(19) United States
(12) Patent Application Publication
(10) Pub. No.: US 2025/0021835 A1
(43) Pub. Date: Jan. 16, 2025

(54) SYSTEM AND METHOD FOR GENERATING RECOMMENDATIONS FROM MULTIPLE DOMAINS

(71) Applicant: JIO PLATFORMS LIMITED, Ahmedabad (IN)

(72) Inventors: Kavindra SHARMA, Gwalior (IN); Amit SACHAN, Bangalore (IN); Akhilesh PAKHETRA, Udhampur (IN)

(73) Assignee: JIO PLATFORMS LIMITED, Ahmedabad (IN)

(21) Appl. No.: 18/713,090

(22) PCT Filed: Nov. 24, 2022
(86) PCT No.: PCT/IB2022/061372

§ 371 Date: May 23, 2024

(30) Foreign Application Priority Data
Nov. 24, 2021 (IN) 202121054286

(51) Int. Cl. G06N 5/022; G06F 16/44

(52) U.S. Cl. CPC G06N 5/022; G06F 16/44

(57) ABSTRACT

The present invention provides solution to the above-mentioned problem in the art by providing a system and a method for efficiently providing personalized content recommendations across multiple domains containing distinct types of contents. The present invention provides numerous improvements over existing systems. The present invention is effective for organizations where business interests span multiple domains. Recommendations are not limited to a single domain. Rather, user events from different domains can be leveraged to make recommendations in any of these domains. For example. News Articles recommendations on Movies and vice-versa (but not limited to only Movies and News). More specifically, if a person is watching a movie, using this invention, we can provide personalized suggestions of news articles to read based on the current frame of movie and user's past behaviour.

### FIELD OF INVENTION

The embodiments of the present disclosure generally relate to providing on-demand services in a network using a database system and, more specifically, to techniques for communicating with components across different domains from a user interface in an online social network providing personalized content recommendations across multiple domains containing distinct types of contents.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Recommendations are one of the most powerful ways people can search and find what they want. Research on computer-generated recommendations has been active for decades and has produced a large number of publications, various solutions and numerous working systems with a range of success. Computer-generated recommendations can be based on a specialized knowledge codification from various sources. This became apparent in the 1970s and 80 s due to oversupply of specialized system-based applications. The problem with this solution is the effort and difficulty in capturing and maintaining expertise in computer applications. Another solution that addresses some of the shortcomings of specialized systems is a machine learning system in which a computer application can improve its performance by adapting itself based on past performance. For recommendations, this solution is expressed in the form of a collaborative filtering algorithm . . . . In this personalized movie recommendation service, thousands of users present movie scores based on how much they like or dislike the movie. A recommendation for a specific user can be created by watching a movie similar to the movie linked by the user. This gives a recommendation of the form “people who like this movie also like the following movies”. For example, a user watching a movie “Jerry Maguire” may get a movie recommendation “A Few Good Men”. In this case, “similarity” is based on analyzing the scores across the entire user population who scored movies that intersect with movies scored by the particular user requesting the recommendation. As shown in the example described above, existing systems in the area of collaborative filtering are focused on creating recommendations based on user input data within a single domain. Since input data is collected only from a single domain, e.g., a movie, recommendations can only be made for items in this domain. Furthermore, the quality of collaborative filtering recommendations depends on the amount of user input data available. However, if only a small amount of data is available for a domain, the recommendations made will be less relevant and less reliable.

Some systems provide recommendations of web sites, web pages, and/or products to a user based on web pages viewed during a current browsing session. However, the system is not applicable in a variety of scenarios and deals with only websites based on user interaction only. Another Recommender method and system for cross-domain recommendation form or uses translations or relations between the known domains and the new domain and by exploiting these translations or relations to extend the profiles in the known domains into the new domain providing recommendations for content items, e.g., a product or service, associated with a new domain to a user using available profile information for content items associated with known domains. However, the recommendations are based on user history, transferring the profile using machine learning methods to another domain without any deep content understanding. Many other contemporary recommendation systems and methods have similar disadvantages. Existing systems in the area of are focused on creating recommendations based on user input data within a single domain. Since input data is collected only from a single domain, e.g., a movie, recommendations can only be made for items in this domain. Furthermore, the quality of recommendations depends on the amount of user input data available. However, if only a small amount of data is available for a domain, the recommendations made will be less relevant and less reliable.

Therefore, there is a need for a system and method that can address the problem of creating recommendations for creating product or service recommendations from multiple domains and mitigate the limitations in the art.

### Objects of the Present Disclosure

Some of the objects of the present disclosure, which at least one embodiment herein satisfies are as listed herein below.

It is an object of the present disclosure to provide a knowledge graph along with conceptual division of content into multiple blocks.

It is an object of the present disclosure to provide an approach that eliminates the requirement of manually defining relationships between cross-domain items.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a system for generating recommendation for providing input services. The system may include one or more processors operatively coupled to a plurality of computing devices, the one or more processors may be coupled with a memory that may store instructions which when executed by the one or more processors and cause the system to receive one or more content inputs from the plurality of computing devices, the one or more content inputs associated with a predefined domain and then extract a first set of attributes from the received one or more content inputs, the first set of attributes pertaining to one or more contextual parameters associated with the one or more content input. Based on the extracted first set of attributes, the system may be configured to divide, the one or more content inputs into a plurality of independent blocks. The system may be configured to extract a second set of attributes from the plurality of independent blocks, the second set of attributes pertaining to the predefined domain and a predefined event present in the plurality of independent blocks. The system may be further configured to extract a third set of attributes from the plurality of independent blocks, the third set of attributes pertaining to predefined information associated with each independent block. Based on the extracted second and third set of attributes, the system may determine a weight to be assigned to each said independent blocks, the weight pertaining to an importance of each block with respect to the second and the third set of attributes extracted and then train, by a machine learning engine, the one or more content inputs received based on the second and the third set of attributes and a predefined dataset obtained from a knowledge graph associated with the domain, the ML engine being associated with the one or more processors. The system may be further configured to generate, a trained model based on the trained one or more content inputs; and then auto-recommend, a final contextual block, based on the generated trained model, the final contextual block comprising one or more independent blocks with the highest weight.

In an embodiment, the one or more content inputs may pertain to any or a combination of images, video streams, audio streams and textual content.

In an embodiment, the knowledge graph may be provided with predefined markers using time-based split for the video streams and audio streams and location-based split for the textual content.

In an embodiment, the predefined information may pertain to a plurality of sentiment, mood parameters, language and dialect parameters across a plurality of regions and users.

In an embodiment, the importance of the predefined weight assigned to each independent block may be determined based on position of occurrence, co-occurrence with predetermined information of the domain.

In an embodiment, the system may be configured to: receive information from a plurality of information sources, determine an affinity of the received information with the third set of attributes; and aggregate the affinity associated with the plurality of information sources to obtain the final contextual block.

In an embodiment, the one or more content inputs may be inserted as a node.

In an embodiment, the system is further configured to calculate similarity, by a graph traversal and embeddings-based engine, between a plurality of content inputs of the predefined domain and a plurality of cross-domains, the plurality of cross-domains referring to nature of the cross-domains different from the predefined domain.

In an embodiment, the system may be further configured to: filter the plurality of content inputs based on a user interaction such as watch history, click, detail page visit, summary viewed, added to wish list, preferred language, location of the users and preferences and then re-rank the plurality cross-domains to be recommended to an independent block associated with the predefined domain.

In an embodiment, the system may be further configured to assign appropriate weight to an independent block according to a domain associated with an entity; extract, from a plurality of information sources, information associated with the independent block; determine, a domain specific affinity between the independent block and the plurality of information sources; and, based on the affinity determined, connect the independent block with the plurality of cross-domains using the knowledge graph.

In an aspect, the present disclosure provides for a user equipment (UE) for generating recommendation for providing input services. The UE may include one or more processors operatively coupled to a plurality of computing devices, the one or more processors may be coupled with a memory that may store instructions which when executed by the one or more processors and cause the UE to receive one or more content inputs from the plurality of computing devices, the one or more content inputs associated with a predefined domain and then extract a first set of attributes from the received one or more content inputs, the first set of attributes pertaining to one or more contextual parameters associated with the one or more content input. Based on the extracted first set of attributes, the UE may be configured to divide, the one or more content inputs into a plurality of independent blocks. The UE may be configured to extract a second set of attributes from the plurality of independent blocks, the second set of attributes pertaining to the predefined domain and a predefined event present in the plurality of independent blocks. The UE may be further configured to extract a third set of attributes from the plurality of independent blocks, the third set of attributes pertaining to predefined information associated with each independent block. Based on the extracted second and third set of attributes, the UE may determine a weight to be assigned to each said independent blocks, the weight pertaining to an importance of each block with respect to the second and the third set of attributes extracted and then train, by a machine learning engine, the one or more content inputs received based on the second and the third set of attributes and a predefined dataset obtained from a knowledge graph associated with the domain, the ML engine being associated with the one or more processors. The UE may be further configured to generate, a trained model based on the trained one or more content inputs; and then auto-recommend, a final contextual block, based on the generated trained model, the final contextual block comprising one or more independent blocks with the highest weight.

In an aspect, the present disclosure provides for a method for generating recommendation for providing input services. The method may include the step of receiving, by one or more processors, one or more content inputs from the plurality of computing devices, the one or more content inputs associated with a predefined domain. The one or more processors may be operatively coupled to a plurality of computing devices, the one or more processors may be further coupled with a memory that stores instructions which are executed by the one or more processors. The method may further include the step of extracting, by the one or more processors, a first set of attributes from the received one or more content inputs, the first set of attributes pertaining to one or more contextual parameters associated with the one or more content input. Based on the extracted first set of attributes, the method may further include the step of dividing, by the one or more processors, the one or more content inputs into a plurality of independent blocks and the step of extracting, by the one or more processors, a second set of attributes from the plurality of independent blocks, the second set of attributes pertaining to the predefined domain and a predefined event present in the plurality of independent blocks. The method may further include the step of extracting, by the one or more processors, a third set of attributes from the plurality of independent blocks, the third set of attributes pertaining to predefined information associated with each independent block. Based on the extracted second and third set of attributes, the method may further include the step of determining, by the one or more processors, a weight to be assigned to each said independent blocks, the weight pertaining to an importance of each block with respect to the second and the third set of attributes extracted and the step of training, by a machine learning engine, the one or more content inputs received based on the second and the third set of attributes and a predefined dataset obtained from a knowledge graph associated with the domain, wherein the ML engine is associated with the one or more processors. The method may further include the step of generating, a trained model based on the trained one or more content inputs; and the step of auto-recommending, a final contextual block, based on the generated trained model, the final contextual block comprising one or more independent blocks with the highest weight.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture (100) in which or with which the system of the present disclosure can be implemented, in accordance with an embodiment of the present disclosure.

FIG. 2A illustrates an exemplary representation (200) of the system (110), in accordance with an embodiment of the present disclosure.

FIG. 2B illustrates an exemplary representation (200) of a user equipment (UE), in accordance with an embodiment of the present disclosure.

FIGS. 3A-3C illustrates an exemplary method flow diagram depicting a method for in accordance with an embodiment of the present disclosure.

FIG. 4 illustrates an exemplary block diagram representation of the proposed system, in accordance with an embodiment of the present disclosure.

FIG. 5 illustrates an exemplary representation of sub modules of the proposed method, in accordance with an embodiment of the present disclosure.

FIG. 6 illustrates an exemplary block diagram of the functional modules of the proposed system and its implementation, in accordance with an embodiment of the present disclosure.

FIG. 7 illustrates an exemplary computer system in which or with which embodiments of the present invention can be utilized in accordance with embodiments of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

The present invention provides solution to the above-mentioned problem in the art by providing a system and a method for efficiently providing personalized content recommendations across multiple domains containing distinct types of contents. The present invention provides numerous improvements over existing systems. The present invention is effective for organizations where business interests span multiple domains. Recommendations are not limited to a single domain. Rather, user events from different domains can be leveraged to make recommendations in any of these domains. For example, News Articles recommendations on Movies and vice-versa (but not limited to only Movies and News). More specifically, if a person is watching a movie, using this invention, we can provide personalized suggestions of news articles to read based on the current frame of movie and user's past behaviour. Similarly, if a person is reading a news article, this invention can provide recommendations of movies/songs based on the article and current reading position such as but not limited to a Headline or a particular paragraph in news in a personalized manner. This invention can provide recommendation for content belonging to multiple language such for example news article text can be in Hindi, English, Bagnoli, Telegu. Similarly, movies content metadata and audio can be in English as well as in other Indian language too.

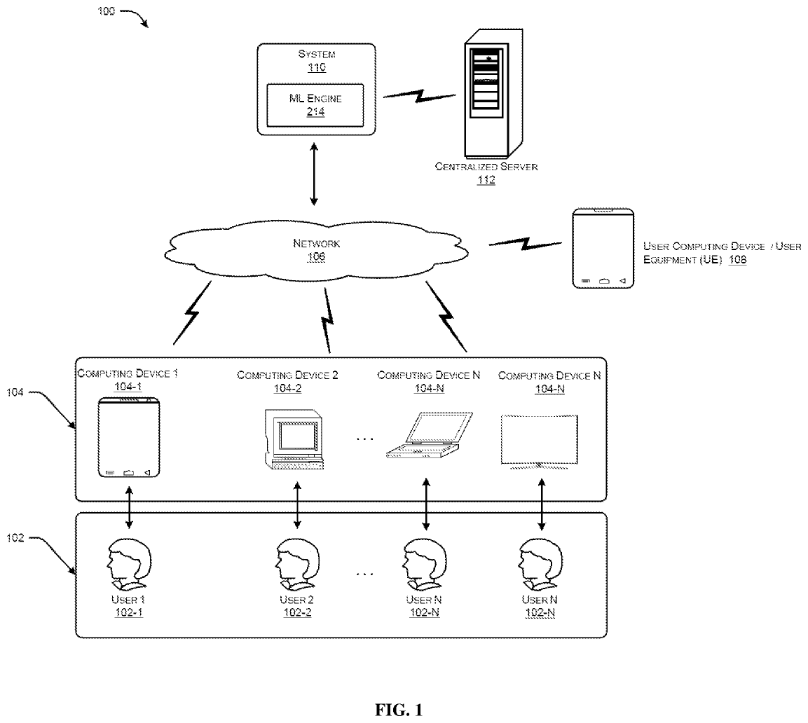

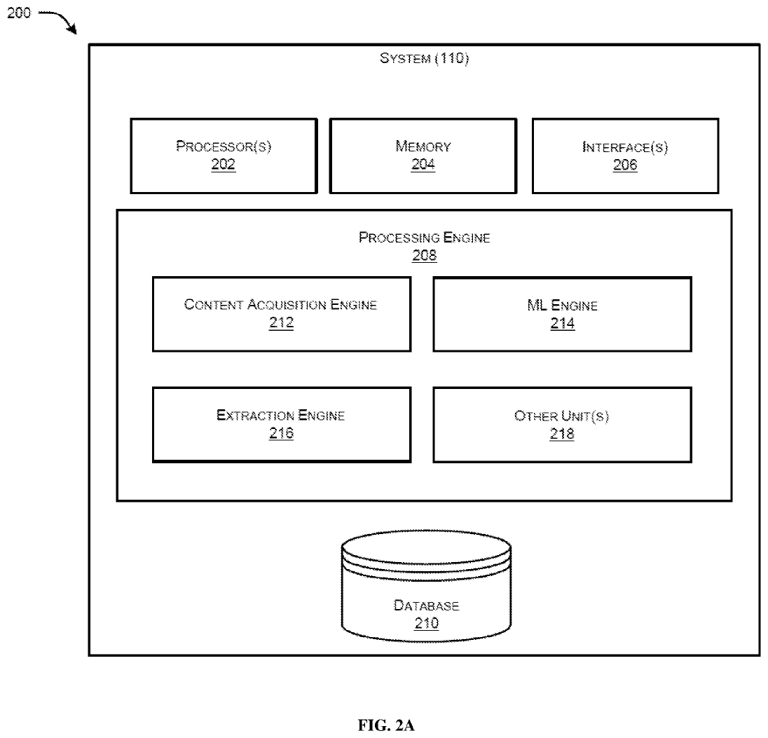

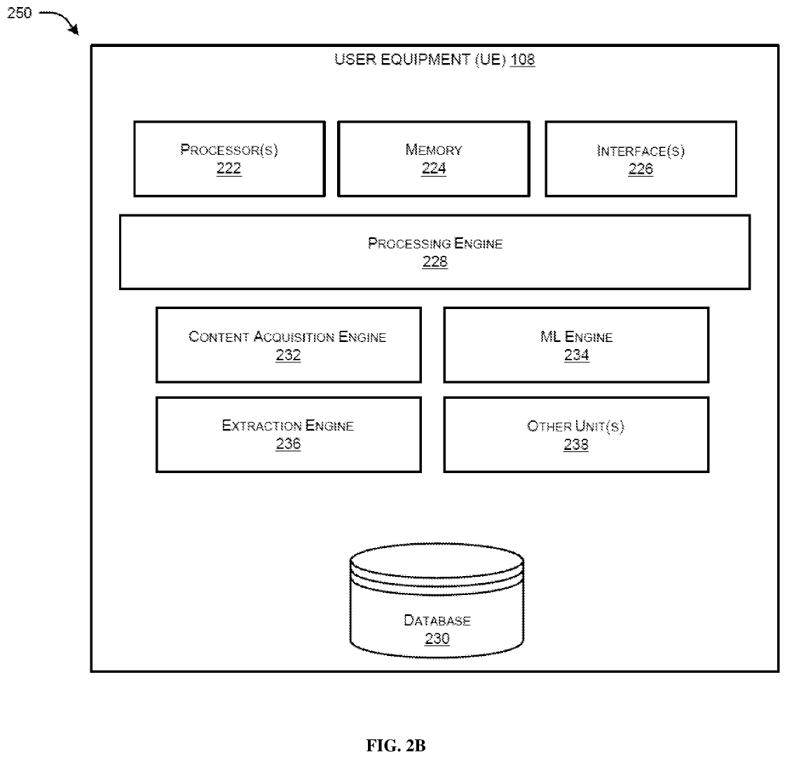

Referring to FIG. 1 that illustrates an exemplary network architecture (100) in which or with which system (110) of the present disclosure can be implemented, in accordance with an embodiment of the present disclosure. As illustrated, the exemplary architecture (100) includes a system (110) equipped with a machine learning (ML) engine (214) (Ref. FIG. 2A) for providing personalized content recommendations across a plurality of domains containing distinct types of contents. One or more contents may be received from a plurality of users (102-1, 102-2, . . . 102-n) (hereinafter interchangeably referred as user or client; and collectively referred to as users 102). Each user may be associated with at least one computing device (104-1, 104-2, . . . 104-n) (hereinafter interchangeably referred as a smart computing device; and collectively referred to as 104). The users (102) may interact with the system (110) by using their respective computing device (104). The computing device (104) and the system (110) may communicate with each other over a network (106). The system (110) may be associated with a centralized server (112). Examples of the computing devices (104) can include, but are not limited to, a computing device (104) associated with media entities and entertainment based assets, education sector, a smart phone, a portable computer, a personal digital assistant, a handheld phone and the like.

In an embodiment, the computing device (104) may be further associated with another user computing device (108) (also referred to as user equipment (UE)) that can be associated with one or more users (102) through the network (106). The UE (108)

Further, the network (106) can be a wireless network, a wired network, a cloud or a combination thereof that can be implemented as one of the different types of networks, such as Intranet, BLUETOOTH, MQTT Broker cloud, Local Area Network (LAN), Wide Area Network (WAN), Internet, and the like. Further, the network 106 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like. In an exemplary embodiment, the network 104 can be an HC-05 Bluetooth module which is an easy to use Bluetooth SPP (Serial Port Protocol) module, designed for transparent wireless serial connection setup

According to various embodiments of the present disclosure, the system (100) can provide for a machine learning (ML) based recommendation generation by using knowledge graph, particularly for providing input services. In an illustrative embodiment, the ML based techniques can include, but not limited to, a graph traversal and embeddings-based algorithms such as common nodes-based algorithms, graph convolutional methods and the like to calculate similarity between entities present in KG that can be contents from different domains for example, between a Movie and a News Article or person entity (for example actor, director, producer) and any attribute associated with content such as genre of movie, category of news articles. The technique and other data model involved in the use of the technique can be accessed from a database in the server.

In an aspect, the system (110) can receive a content input from the computing device (104). In an embodiment, the system (110) can extract a first set of attributes from the content input. Based on the extracted first set of attributes, the content input can be divided the into a plurality of independent blocks (also referred to blocks hereinafter) wherever possible. As an example, but not as a limitation, movies can be divided into individual scenes and news articles can be divided into multiple paragraphs. The key contribution of the plurality of independent blocks is finding the importance of blocks according to various context, such as hit dialogue spoken, most watched scene, most important part of news article.

The system (110) may then extract a second set of attributes pertaining to the entity and an event present in the plurality of independent blocks and based on the extracted set of attributes, the plurality of independent blocks can be provided with weights in accordance of importance of the blocks. The blocks can be represented in a knowledge graph with appropriate markers using time-based split for Media items like songs, movie, and the like. And location-based split for News items, where individual unit can be a paragraph.

The system (110) may be further configured to extract a third set of attributes pertaining to proper information from different types of relevant information from diverse types of content and content blocks. For example, Publishers, entities, events, context, and sentiments can be extracted from news articles. Metadata (e.g., actors, directors), actors in different scenes, the mood in movie scenes can be extracted. For movies, the system (110) can extract information from various sources such as from metadata, from video and audio in a scene to differentiate between sentiment verses Mood matching.

In an embodiment, the system (110) may be configured to train, by a machine learning engine (214), the one or more content inputs received based on the second and the third set of attributes and a predefined dataset obtained from a knowledge graph associated with the predefined domain and then generate, a trained model based on the trained one or more content inputs. The system (110) may then auto-recommend, a final contextual block, based on the generated trained model, the final contextual block comprising one or more independent blocks with the highest weight.

In an exemplary embodiment, the system (110) can assign appropriate weightage based on the extracted third set of attributes such as position of occurrence, co-occurrence with other kinds of information of the domain. Various NLP (Natural Language Processing) and computer vision-based techniques can be used for assigning weightage. Finally, the affinities from a plurality of information sources can aggregated to obtain a final contextual block.

In an exemplary embodiment, the content input can be inserted as a node along with other information as properties of node or edges with the calculated weightages.

In another exemplary embodiment, the system (110) may be configured with a graph traversal and embeddings-based engine to calculate similarity between a plurality of contents from a plurality of domains for example between a movie and a news article. The block presents an ensemble algorithm using multiple techniques we use for graph traversal. Some of the algorithms include Common nodes-based algorithms and Graph convolutional methods.

In another exemplary embodiment, the system (110) may include re-ranking and personalized filtering the plurality of contents based on the user interaction such as watch history, click, detail page visit, summary viewed, added to wish list, preferred language, location of the users and preferences to re-rank the cross-domain contents recommended for a block.

In an exemplary embodiment, representation of content such as bit not limited to Media or News items in part may be done in knowledge graph. This will help in finding specific advertising opportunities or recommendation opportunities for each part of the Media or News content.

In an exemplary embodiment, the system (110) may include determining an affinity between the content and various kind of entity present associated with the content (also referred to as item herein). For example, for movies genre, actor, place, vehicles, instrument, arms extracted from text, audio and video data.

In an exemplary embodiment, the system may assign appropriate weight according to a domain to the entity extracted from various kind of data and find out final affinity between one entity and item, that will be domain specific affinity and then connecting items from various domain with help of common entities present using knowledge graph. With the help of an ML engine (214), affinity between 2nd, 3rd . . . order connection entities can be determined. For example, affinity between actor and vehicle getting used by him in the movies and then finding out the associated entity and items for a given item in one domain and recommend them in target domain. With help of the user profile, which have the affinity associated between the user and entity (user profile is also using affinity between item and entity from KG), the system (110) may rank the item in target domain personalized to the user.

Alternatively, the system can be extended to any domain which have items text, audio and/or image data associated with it such as retail, news, music but not limited to the like.

FIG. 2A illustrates an exemplary representation (200) of system (110), in accordance with an embodiment of the present disclosure.

In an aspect, the system (110) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) 206 may comprise a variety of interfaces, for example, interfaces for data input and output devices, referred to as I/O devices, storage devices, and the like. The interface(s) 206 may facilitate communication of the system (110). Examples of such components include, but are not limited to, processing engine(s) 208 and a database (210).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a content acquisition engine (210), an ML engine (214), an extraction engine (216) and other units (218). The other units (218) may include a graph traversal and embeddings-based engine, a natural language processing (NLP) engine and the like.

FIG. 2B illustrates an exemplary representation (200) of the user equipment (UE) (108), in accordance with an embodiment of the present disclosure.

In an aspect, the UE (108) may comprise a processor (222). The more processor (222) may be implemented as one or more microprocessors, microcomputers, microcontrollers, digital signal processors, central processing units, logic circuitries, and/or any devices that process data based on operational instructions. Among other capabilities, the processor(s) (222) may be configured to fetch and execute computer-readable instructions stored in a memory (224) of the UE (108). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (108) may include an interface(s) 206. The interface(s) 206 may comprise a variety of interfaces, for example, interfaces for data input and output devices, referred to as I/O devices, storage devices, and the like. The interface(s) 206 may facilitate communication of the UE (108). Examples of such components include, but are not limited to, processing engine(s) 228 and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (228) may be implemented by electronic circuitry.

The processing engine (228) may include one or more engines selected from any of a content acquisition engine (232), an ML engine (234), an extraction engine (236) and other units (238). The other units (238) may include a graph traversal and embeddings-based engine, a natural language processing (NLP) engine and the like.

### EXEMPLARY SCENARIOS

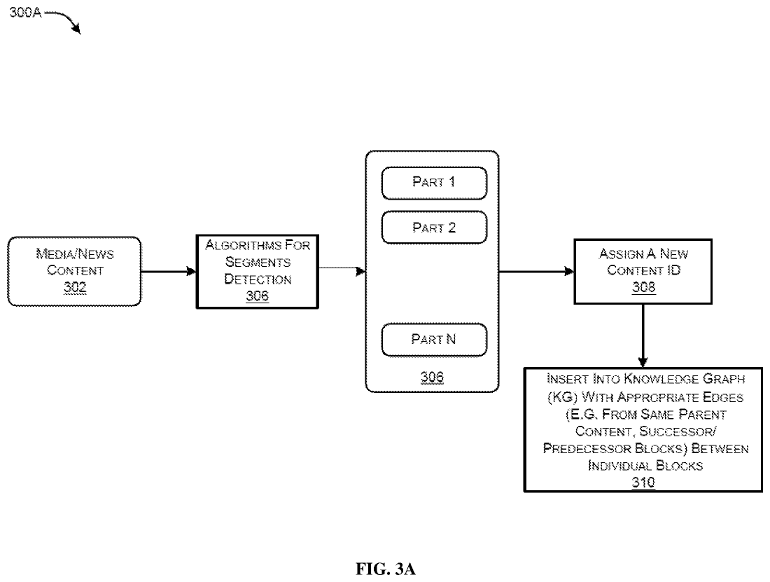

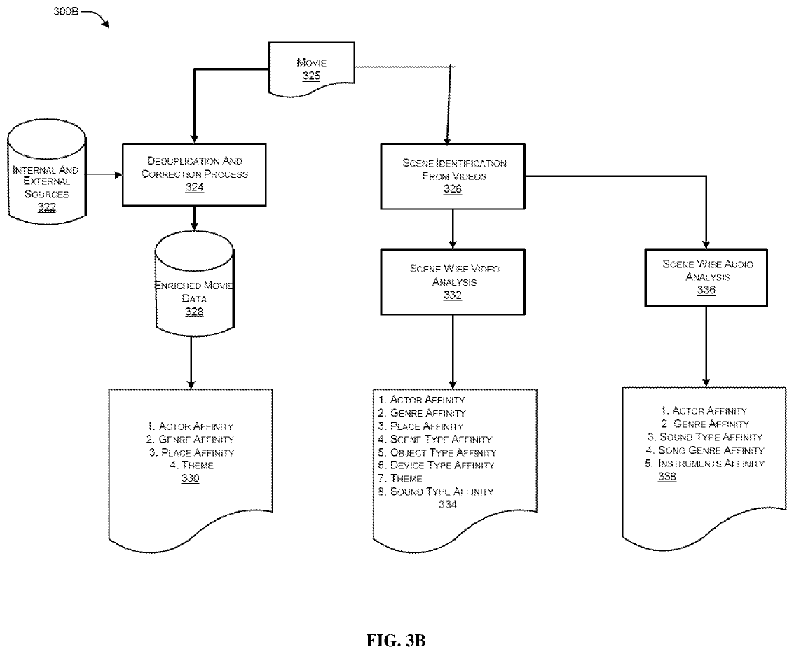

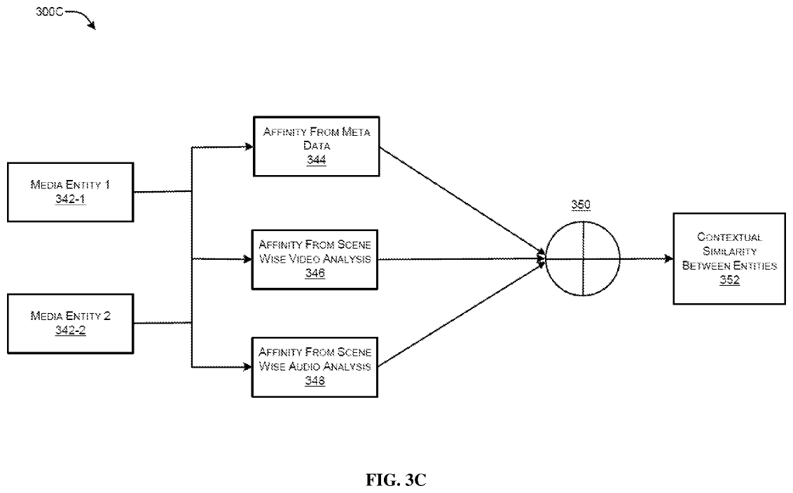

FIGS. 3A-3C illustrates an exemplary method flow diagram (300) depicting a method for in accordance with an embodiment of the present disclosure. In an aspect, the method flow diagram in FIG. 3A may include media/news content (302) that can be sent to algorithms for segments detection (304) into N parts (306). A new content ID may be assigned (308) and then inserted into a knowledge graph (KG) with appropriate edges for example same parent content, successor/predecessor blocks between individual blocks. This consists of algorithms to divide the content from different domains into independent blocks (wherever possible). As an example, movies can be divided into individual scenes and news articles can be divided into multiple paragraphs.

In an exemplary embodiment, a key contribution of the block is finding the importance of blocks according to various context, such as hit dialogue spoken, most watched scene, most important part of news article. Once we know all the blocks importance, we can give weightage to entity and event present in those blocks accordingly. The conceptual blocks can be represented in knowledge graph with appropriate markers using time-based split for Media items like songs, movie, etc. And location-based split for News items, where individual unit can be a paragraph. This is very much helpful for finding out recommendations and advertising opportunities for each individual block separately. With Knowledge graph along with conceptual division, we will be able to find better relationships as information is at very granular level as described in the diagram below.

FIG. 3B illustrates an example embodiment of a content that may include a movie (325) received from external and internal sources (322) that undergoes deduplication and correction process (324) and scene identification from videos (328). The deduplication and correction process (324) provides an enriched movie data (328) that provides affinity between actors, genres, place, theme and the like (330). The scene identification from videos (332) provides affinity between actors, genres, place, scene, object type, device type, theme type and sound type and the like (334). The scene wise analysis (336) provides affinity between actors, genres, sound type and instruments type and the like (338). For example, from video scene an actor is present in how many frames can be known. This will bet the actors' affinity for scene. But it can be the case that the actor is present in that scene but not actively involved in that scene, because the actor is just present with other actors and might not be speaking any dialogue, and that information will come from an audio analysis. The audio analysis scene may be performed to know which actor is speaking more words in a scene and that will act as affinity for actor for that scene.

Likewise, a genre may be obtained from the metadata, but that might not always be correct and might not be the true representation of the movie, and it is very much possible that one movie has many genres in it, so scene wise analysis of genre will help in understanding the genre affinity at scene level and at overall movie level. Scene wise video analysis of genre will not only help in giving total distribution of genre in a movie, but also give the genre according to movie timeline. Scene wise audio analysis will also help in getting genre affinity for that scene more accurately

In an exemplary embodiment, to extract proper information from different types of relevant information from diverse types of content and content blocks. E.g., Publishers, entities, events, context, and sentiments can be extracted from news articles. Metadata (e.g., actors, directors), actors in different scenes, the mood in movie scenes can be extracted as illustrated in FIGS. 3B and 3C. For movies, information can be extracted from various sources such as from metadata, from video and audio in a scene. Various information relevant to movies can be extraction from all these sources such as For example, from metadata (344) how many and which actors are present can be known, but knowing that which actor have more influence on the movie or to be more precise in that scene is not possible from metadata, for that video and audio scene analysis (346, 348) is required. Final output of this step will be having affinity of different entity and events for a content at scene (Block) level.

In an exemplary embodiment, the method may include assigning appropriate weightage (350) to the extracted information from the context (e.g., position of occurrence, co-occurrence with other kinds of information) of the domain. Various NLP (Natural Language Processing) and computer vision-based techniques are part of this block. Finally, the affinities from multiple information sources are aggregated to obtain the final contextual similarity between the entities (352).

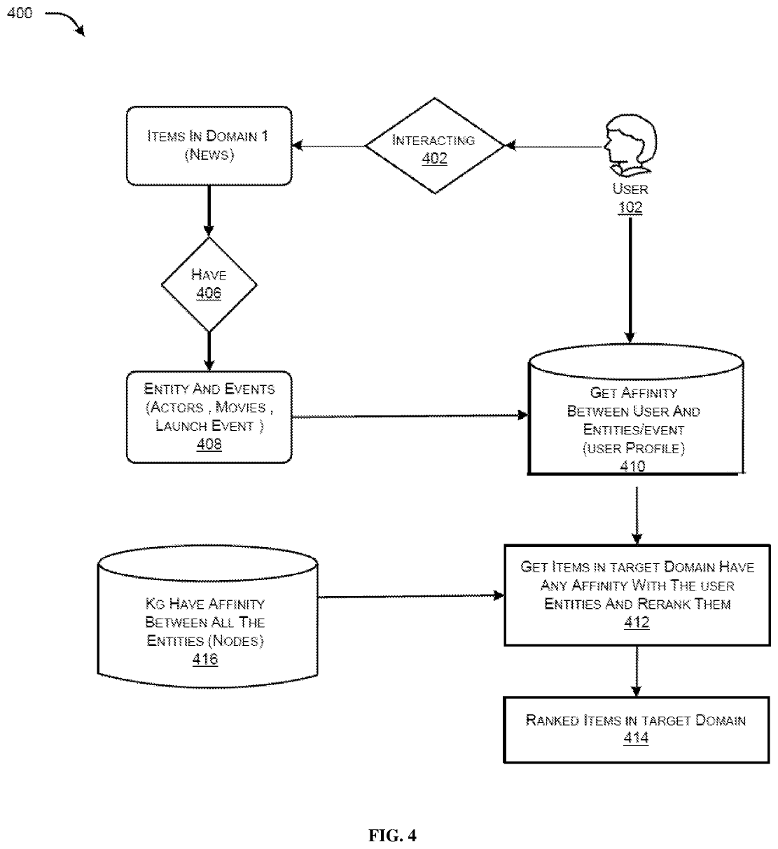

FIG. 4 illustrates an exemplary block diagram representation (400) of the proposed system, in accordance with an embodiment of the present disclosure. As illustrated, in an exemplary representation, a user (102) may interact (402) with a domain 1 such as news (404) that may have entities (406) and events (408) such as actors, movies, launch events. The user's watch history and preferences may be used to re-rank the cross-domain contents recommended for a block.

In an exemplary embodiment, the content can be inserted as a node along with other information as properties of node or edges with calculated weightages. A graph traversal and embeddings-based algorithms to calculate similarity between contents from different domains (e.g., between a Movie and a News Article). The block presents an ensemble algorithm using multiple techniques used for graph traversal. The method gets affinity between the user and the event and the entity (410) and items may be obtained in the target domain that have an affinity with the user entities and then re-ranking (412) of the items take place. The affinity of the user towards an event and entity may be determined.

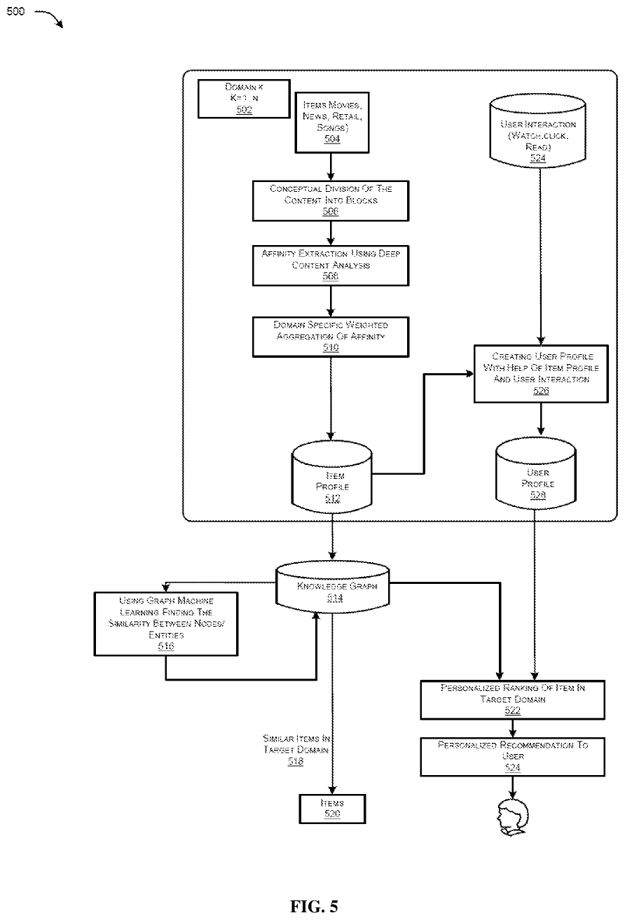

FIG. 5 illustrates an exemplary representation (500) of sub modules of the proposed method, in accordance with an embodiment of the present disclosure. As illustrated in FIG. 5, the first part is item-profile (512) from each domain, which includes detailed information about the item (504). For example, for movies, it will have all the attributes, i.e. genre, actor, director, production house, release date, context (Location, time, device) related behavior of the movie. For news, it will have a category, an entity present in a news article, event present in a news article, and the like. The item profile (512) may be obtained by conceptual Division of the content into Blocks (506), affinity extraction using deep content analysis (508), in-domain contextual weight assignment (510) for affinity. The method (500) may further include creation of a user profile from the item profile and user interaction (526).

In an embodiment, the method (500) may include a second component that is a knowledge Graph Database (514), which will have all the entities present from all the domains as nodes and the relation between them as edge (516).

In an embodiment, the method (500) may include a third component that is a Similarity calculation module (518) for finding the similarity between the entity present in the Graph Database and generate the items (520).

In an embodiment, the method (500) may include a fourth component which is the user profile (528) from all the domains, which will be used to find personalized commendation for that domain.

In an embodiment, the method (500) may include a fifth component which is a ranking part (522) to provide personalized recommendation (524) to the user (102).

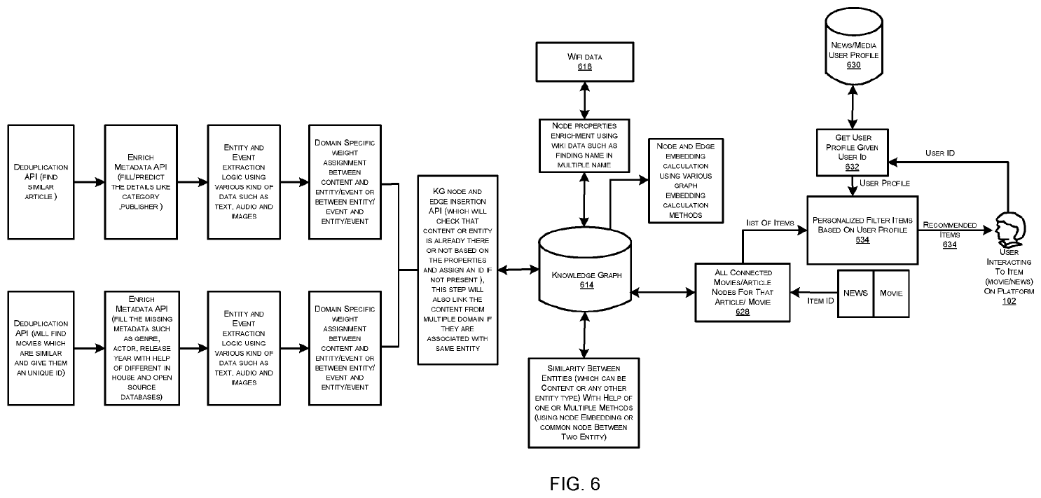

FIG. 6 illustrates an exemplary block diagram of the functional modules of the proposed system and its implementation, in accordance with an embodiment of the present disclosure. In an exemplary embodiment, the method being implemented on the system may include the steps of deduplication of the content, because it is possible to have information about the same item from various sources, such as one movie metadata can be present from various provider, or same news article getting published from various publisher, deduplication step involving merging the information about the content. Next step is to enrich and correct the metadata of the content with the help of various sources. Next step is extracting the all-possible entity and event present in the content and relevant information about those entity and event such as names in different language, DOB of the person entity. Next step is giving weight to the entity and event according to the domain and source information. Entity and events can be extracted from structured data such as metadata attributes for example what is the genre of movie, which actors are present in the movies, similarly for the news it can be publisher information, genre/category of the news article or from unstructured data such as text (can be description of movie, subtitle of movie, headline of news article), image (poster image of news article, poster image of movie etc) and audio/video associated with the content. Next step is of defining that which entities to keep in knowledge graph and defining their properties (602-608), entity type can be genre, star cast, director etc. and the properties can be DOB, industry related to, Images, Recent movies, Lead actor in number of movies, famous movies. The method may further include the step of defining the edge and their properties such as defining the type and weight of edge, which are essentially the relation between nodes (entities) (610-612). For example, star cast to movie, article to category, article to publisher and the like. The method may include the step of inserting data for those entity and relations. The data may be taken from item profile and insert into predefined format in the graph database (614).

The method may include the step of Graph Cleaning and pruning. Some of the entities are edge can be outlier, can have very few or lots of edges connected to them, we find outlier like these and make appropriate decision such as split the node in granular one in case of hyper node or delete that. Node or edge embedding calculation (622) can be done using various graph learning based methods which will essentially help in finding out the similarity between nodes or edges. Next step is to find similarity between the nodes (620-626), for this we can use embedded methods which will have similarity between nodes or edges from multiple methods, different methods can be applied with weight. Few examples of methods are: finding the common nodes between them of degree N, then calculating weighted similarity score based of weight of different entity type and relation type. Another method can be embedding based similarity. Similarity can also be insert between two nodes from some external sources for example similarity between two movies or news article from collaborative filtering methods, deep learning based methods (Autoencoder, CNN, RNN etc).

The method may further include the step of personalized ranking of items (634). Once, similar items (628) for a given movies or news article we can rank them with the help of user profile of target domain. User profile will have entity or events affinity related to users based on various interaction users have done in target domain. Similar items for a movie or news article will also have entity or events related to them, with help of common entity/events in user's user profile and item we will give personalised ranked item list to the end user.

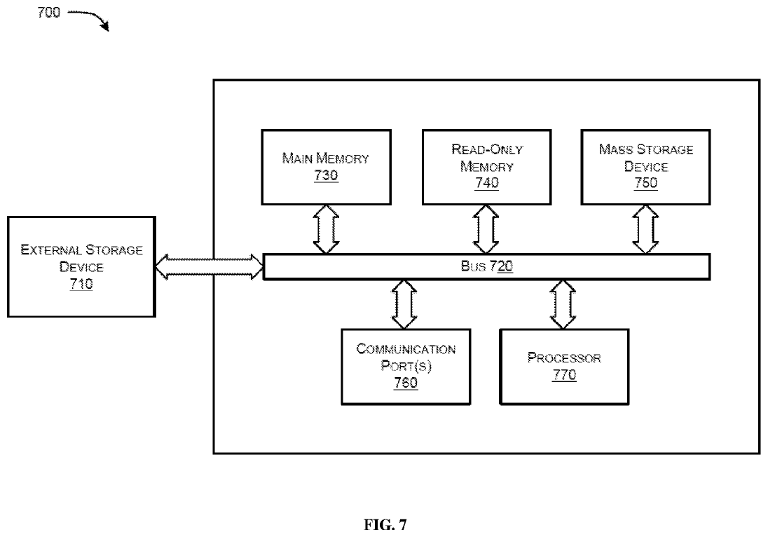

FIG. 7 illustrates an exemplary computer system in which or with which embodiments of the present invention can be utilized in accordance with embodiments of the present disclosure. As shown in FIG. 7, computer system 700 can include an external storage device 710, a bus 720, a main memory 730, a read only memory 740, a mass storage device 770, communication port 760, and a processor 770. A person skilled in the art will appreciate that the computer system may include more than one processor and communication ports. Processor 770 may include various modules associated with embodiments of the present invention. Communication port 760 may be chosen depending on a network to which computer system connects. Memory 730 can be Random Access Memory (RAM), or any other dynamic storage device commonly known in the art. Read-only memory 740 can be any static storage device(s). Mass storage 770 may be any current or future mass storage solution, which can be used to store information and/or instructions.

Bus 720 communicatively couples processor(s) 770 with the other memory, storage and communication blocks. Optionally, operator and administrative interfaces, e.g. a display, keyboard, joystick and a cursor control device, may also be coupled to bus 720 to support direct operator interaction with a computer system. Other operator and administrative interfaces can be provided through network connections connected through communication port 760. Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

We claim:

1. A system (110) for generating recommendation for providing input services, said system (110) comprising;
one or more processors (202) operatively coupled to a plurality of computing devices (104), the one or more processors (202) coupled with a memory (204), wherein said memory (204) stores instructions which when executed by the one or more processors (202) causes said system (110) to:
receive one or more content inputs from the plurality of computing devices (104), the one or more content inputs associated with a predefined domain;
extract a first set of attributes from the received one or more content inputs, the first set of attributes pertaining to one or more contextual parameters associated with the one or more content input;
based on the extracted first set of attributes, divide, the one or more content inputs into a plurality of independent blocks;
extract a second set of attributes from the plurality of independent blocks, the second set of attributes pertaining to the predefined domain and a predefined event present in the plurality of independent blocks;
extract a third set of attributes from the plurality of independent blocks, the third set of attributes pertaining to predefined information associated with each independent block;
based on the extracted second and third set of attributes, determine a weight to be assigned to each said independent blocks, the weight pertaining to an importance of each block with respect to the second and the third set of attributes extracted;
train, by a machine learning engine (214), the one or more content inputs received based on the second and the third set of attributes and a predefined dataset obtained from a knowledge graph associated with the domain;
generate, a trained model based on the trained one or more content inputs; and
auto-recommend, a final contextual block, based on the generated trained model, the final contextual block comprising one or more independent blocks with the highest weight.

2. The system (110) as claimed in claim 1, wherein the one or more content inputs pertain to any or a combination of images, video streams, audio streams and textual content.

3. The system (110) as claimed in claim 1, wherein the knowledge graph is provided with predefined markers using time-based split for the combination of video streams and audio streams and location-based split for the textual content.

4. The system (110) as claimed in claim 1, wherein the predefined information pertains to a plurality of sentiment and mood, language and dialect parameters across a plurality of regions and users.

5. The system (110) as claimed in claim 1, wherein the importance of the predefined weight assigned to each independent block is determined based on position of occurrence, co-occurrence with pre-determined information of the domain.

6. The system (110) as claimed in claim 1, wherein the system (110) is configured to:
receive information from a plurality of information sources;
determine an affinity of the received information with the third set of attributes; and
aggregate the affinity associated with the plurality of information sources to obtain the final contextual block.

7. The system (110) as claimed in claim 1, wherein the one or more content inputs are inserted as a node.

8. The system as claimed in claim 1, wherein the system is further configured to:
calculate similarity, by a graph traversal and embeddings-based engine, between a plurality of content inputs of the pre-defined domain and a plurality of cross-domains, wherein the plurality of cross-domains refers to nature of the cross-domains different from the predefined domain.

9. The system (110) as claimed in claim 1, wherein the system is further configured to:
filter the plurality of content inputs based on a user interaction such as watch history, click, detail page visit, summary viewed, added to wish list, preferred language, location of the users and preferences;
re-rank the plurality cross-domains to be recommended to an independent block associated with the predefined domain.

10. The system (110) as claimed in claim 1, wherein the system is further configured to:
assign appropriate weight to an independent block according to a domain associated with an entity;
extract, from a plurality of information sources, information associated with the independent block; and,
determine, a domain specific affinity between the independent block and the plurality of information sources; and,
based on the affinity determined, connect the independent block with the plurality of cross-domains using the knowledge graph.

11. A user equipment (UE) (108) for generating recommendation for providing input services, said UE comprising;
a processor (222) operatively coupled to a receiver, the processor (222) coupled with a memory (224), wherein said memory (224) stores instructions which when executed by the one or more processors (222) causes said UE to:
receive one or more content inputs from the receiver, the one or more content inputs associated with a predefined domain;
extract a first set of attributes from the received one or more content inputs, the first set of attributes pertaining to one or more contextual parameters associated with the one or more content input;
based on the extracted first set of attributes, divide, the one or more content inputs into a plurality of independent blocks;
extract a second set of attributes from the plurality of independent blocks, the second set of attributes pertaining to the predefined domain and a predefined event present in the plurality of independent blocks;
extract a third set of attributes from the plurality of independent blocks, the third set of attributes pertaining to predefined information associated with each independent block;
based on the extracted second and third set of attributes, determine a weight to be assigned to each said independent blocks, the weight pertaining to an importance of each block with respect to the second and the third set of attributes extracted;
train, by a machine learning engine (214), the one or more content inputs received based on the second and the third set of attributes and a predefined dataset obtained from a knowledge graph associated with the domain;
generate, a trained model based on the trained one or more content inputs; and
auto-recommend, a final contextual block, based on the generated trained model, the final contextual block comprising one or more independent blocks with the highest weight.

12. A method for generating recommendation for providing input services, said method (110) comprising;
receiving, by one or more processors (202), one or more content inputs from the plurality of computing devices (104), the one or more content inputs associated with a predefined domain, wherein the one or more processors (202) are operatively coupled to a plurality of computing devices (104), the one or more processors (202) further coupled with a memory (204), wherein said memory (204) stores instructions which are executed by the one or more processors (202);
extracting, by the one or more processors (202), a first set of attributes from the received one or more content inputs, the first set of attributes pertaining to one or more contextual parameters associated with the one or more content input;
based on the extracted first set of attributes, dividing, by the one or more processors (202), the one or more content inputs into a plurality of independent blocks;
extracting, by the one or more processors (202), a second set of attributes from the plurality of independent blocks, the second set of attributes pertaining to the predefined domain and a predefined event present in the plurality of independent blocks;
extracting, by the one or more processors (202), a third set of attributes from the plurality of independent blocks, the third set of attributes pertaining to predefined information associated with each independent block;
based on the extracted second and third set of attributes, determining, by the one or more processors (202), a weight to be assigned to each said independent blocks, the weight pertaining to an importance of each block with respect to the second and the third set of attributes extracted;
training, by a machine learning engine (214), the one or more content inputs received based on the second and the third set of attributes and a predefined dataset obtained from a knowledge graph associated with the domain;
generating, a trained model based on the trained one or more content inputs; and
auto-recommending, a final contextual block, based on the generated trained model, the final contextual block comprising one or more independent blocks with the highest weight.

13. The method as claimed in claim 12, wherein the one or more content inputs pertain to any or a combination of images, video streams, audio streams and textual content.

14. The method as claimed in claim 12, wherein the knowledge graph is provided with predefined markers using time-based split for the combination of video streams and audio streams and location-based split for the textual content.

15. The method as claimed in claim 12, wherein the predefined information pertains to a plurality of sentiment, mood, language and dialect parameters across a plurality of regions and users.

16. The method as claimed in claim 12, wherein the importance of the predefined weight assigned to each independent block is determined based on position of occurrence, co-occurrence with predetermined information of the domain.

17. The method as claimed in claim 12, wherein the method further comprises the step of receiving, by the one or more processors (202), information from a plurality of information sources;
determining, by the one or more processors (202), an affinity of the received information with the third set of attributes; and
aggregating, by the one or more processors (202), the affinity associated with the plurality of information sources to obtain the final contextual block.

18. The method as claimed in claim 12, wherein the one or more content inputs are inserted as a node.

19. The method as claimed in claim 12, wherein the method further comprises the step of:
calculating similarity, by a graph traversal and embeddings-based engine, between a plurality of content inputs of the predefined domain and a plurality of cross-domains, wherein the plurality of cross-domains refers to nature of the cross-domains that is different from the predefined domain.

20. The method as claimed in claim 1, wherein the method further comprises the step of:
filtering, by the one or more processors (202), the plurality of content inputs based on a user interaction such as watch history, click, detail page visit, summary viewed, added to wish list, preferred language, location of the users and preferences;
re-ranking, by the one or more processors (202), the plurality cross-domains to be recommended to an independent block associated with the predefined domain.

21. The method as claimed in claim 12, wherein the method further comprises the step of:
assigning, by the one or more processors (202), an appropriate weight to an independent block according to a domain associated with an entity;
extracting, by the one or more processors (202), from a plurality of information sources, information associated with the independent block; and,
determining, by the one or more processors (202), a domain specific affinity between the independent block and the plurality of information sources; and,
based on the affinity determined, connecting, by the one or more processors (202), the independent block with the plurality of cross-domains using the knowledge graph.
